(19) United States
(12) Patent Application Publication
(10) Pub. No.: US 2011/0074923 A1
(43) Pub. Date: Mar. 31, 2011

(54) IMAGE TRANSMISSION SYSTEM OF NETWORK-BASED ROBOT AND METHOD THEREOF

(75) Inventors: Byung Kwon Choi, Seoul (KR); Woo Sup Han, Yongin-si (KR); Tae Sin Ha, Seoul (KR)

(73) Assignee: SAMSUNG ELECTRONICS CO., LTD., Suwon-si (KR)

(21) Appl. No.: 12/876,469

(22) Filed: Sep. 7, 2010

(30) Foreign Application Priority Data
Sep. 25, 2009 (KR) 10-2009-91261

(51) Int. Cl. H04N 15/00; H04N 5/225; G06K 9/62

(52) U.S. Cl. 348/43; 348/207.1; 382/153; 901/47; 348/E15.001; 348/E05.024

(57) ABSTRACT

Disclosed herein is a system which transmits an image using a lossless compression method in a robot to provide a service over a network and a method thereof. The network-based robot separates an image acquired by a stereo camera into various image formats and transmits the various image formats to a service server. The service server synthesizes the separated image formats to suit an image request such as face recognition, object recognition, navigation or monitoring to restore and provide an original image. When the network-based robot transmits the separated image formats to the server, the original image is transmitted using the lossless method to improve the performance of the server. Even when a service using a new image is added, separated images are transmitted with respect to the image format requested by this service to more flexibly cope with the service using the new image. Since channels are separated in order to receive lossless data, network gain is obtained.

### CROSS-REFERENCE TO RELATED APPLICATIONS

This application claims the benefit of Korean Patent Application No. 2009-0091261, filed on Sep. 25, 2009 in the Korean Intellectual Property Office, the disclosure of which is incorporated herein by reference.

### BACKGROUND

1. Field

Example embodiments relate to a system and method of transmitting an image using a lossless compression method in a robot to provide a service over a network.

2. Description of the Related Art

In general, a mechanical device which performs motion similar to human motion using an electrical or magnetic mechanism is called a robot. Recently, with development of a sensor and a controller, the robot is utilized in various fields. For example, there are household robots, guide robots for public places, transportation robots for manufacturing plants and operator supporting robots. These example robots may provide various services to a user using mobility and motion. Recently, with development of a network such as the Internet, a robot to provide an image service over the network has been developed.

The robot to provide the image service over the network acquires an image using a camera and transmits the acquired camera image to a server in one format. Accordingly, the server provides the image service used for face recognition, object recognition, navigation and remote monitoring in the transmitted image format. However, in order to perform the service such as face recognition, object recognition, navigation or monitoring, various image formats are necessary. For example, image formats (size of 320*240, color and frame rate of 15 frames per second (fps) or more) are used in face recognition and image formats (size of 640*480, color, frame rate of 5 fps or more) are used in object recognition. In other words, various image formats are required to provide optimal services. For instance, transmitting a color image with a size of 640*480 and a frame rate of 15 fps satisfies all the above services and may be used for including face recognition and object recognition. However, an original image may not be transmitted and a lossy compressed image may be transmitted using a compression method. If compression is performed, gain is obtained in terms of network transmission, but deterioration (about −10% to −3%) in recognition performance may be caused due to data loss. As network bandwidth of 802.11n is improved, small sized image may be transmitted in a lossless manner for a robot. However, it is inefficient to transmit an image which satisfies all formats in a lossless transmission manner as described above.

### SUMMARY

Therefore, it is an aspect of the example embodiments to provide an image transmission system of a network-based robot having a stereo camera mounted therein, which separates and synthesizes an image acquired by the stereo camera to efficiently transmit an image satisfying all formats using a lossless method, and a method thereof.

The foregoing and/or other aspects are achieved by providing an image transmission system, including: a camera configured to acquire an image, an image separation unit configured to separate the image acquired by the camera into a plurality of image formats, an image transmission/reception unit configured to store the plurality of separated image formats and to transmit the plurality of stored image formats according to an image request, an image synthesis unit configured to synthesize the plurality of image formats transmitted by the image transmission/reception unit into an image suitable for the image request; and a service server configured to provide an image service using the synthesized image.

The camera may be a stereo camera which is provided in the network-based robot to acquire a color image with a size of 640(X)*480(Y).

The image separation unit may separate the color image with the size of 640(X)*480(Y), which is acquired by the stereo camera, into parts including a monochrome image with a size of 640(X)*480(Y)/color component and a monochrome image with a size of 320(x)*240(y)/color component and transmit the parts to the image transmission/reception unit.

The image separation unit may separate the color image with the size of 640(X)*480(Y) into the monochrome image and the color component, obtain a difference between the color image with the size of 640(X)*480(Y) and an image component with the size of 320(x)*240(y), and transmit the difference to the image transmission/reception unit.

The image transmission/reception unit may include an image transmission unit configured to transmit the plurality of separated image formats over a network according to the image request, and an image reception unit configured to receive and store the plurality of image formats transmitted over the network.

The image transmission unit may further include buffers configured to store the plurality of separated image formats and an image processing unit configured to determine a frame rate to be transmitted by the buffers according to an image reception request of the service server.

The image transmission unit may compress the plurality of image formats to be transmitted by the buffers using a lossless compression method.

The image reception unit may further include buffers configured to store the plurality of image formats transmitted by the image transmission unit and an image client configured to analyze the image request of the service server and to determine the image formats to be transmitted by the buffers.

The image synthesis unit may fetch and synthesize the image formats stored in the buffers into an image suitable for the image request according to the image request of the service server.

The service server may include a face recognition server, an object recognition server, a navigation server and a monitoring server.

The foregoing and/or other aspects are achieved by providing an image transmission system of a network-based robot, including: a robot configured to separate an image acquired by a camera into a plurality of image formats and to transmit the plurality of image formats, and a server configured to synthesize the plurality of image formats and to provide a service, wherein the robot transmits the plurality of image formats to the server over a network.

The robot may include an image separation unit configured to separate the image acquired by the camera into the plurality of image formats, and an image transmission unit configured to store the plurality of separated image formats and to transmit the plurality of stored image formats to the server according to an image request of the server.

The server may include an image reception unit configured to receive and store the plurality of image formats transmitted from the image transmission unit over the network, and an image synthesis unit configured to fetch and synthesize the plurality of stored image formats into an image suitable for the image request according to the image request.

The foregoing and/or other aspects are achieved by providing a method of transmitting an image between a robot and a server over a network, the method including: at the robot, separating, by a first processor, an image acquired by a camera into a plurality of image formats and transmitting the plurality of image formats to the server; and, at the server, synthesizing, by a second processor, the plurality of image formats and providing a service according to an image request.

The robot may separate the color image with a size of 640(X)*480(Y), which is acquired by the camera, into parts including a monochrome image with a size of 640(X)*480(Y)/color component and a monochrome image with a size of 320(x)*240(y)/color component and transmit the parts to the server.

The robot may compress the plurality of image formats using a lossless compression method and transmit the compressed plurality of image formats to the server.

The server may synthesize the plurality of transmitted image formats into an image suitable for the image request and provide a service.

According to an image transmission system of a network-based robot and a method thereof, the network-based robot separates an image acquired by a stereo camera into various image formats and transmits the various image formats to a service server. The service server synthesizes the separated image formats to be suitable for an image request such as face recognition, object recognition, navigation or monitoring to restore and provide an original image as a service. When the network-based robot transmits the separated image formats to the server, the original image is transmitted using the lossless method to improve the performance of the server. Even when a service using a new image is added, separated images are transmitted with respect to the image format requested by this service to more flexibly cope with the service using the new image. Since channels are separated in order to receive lossless data, network gain is obtained.

Additional aspects, features, and/or advantages of embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is an appearance view showing an example of a network-based robot according to example embodiments;

FIG. 2 is a view showing the overall configuration of an image transmission system of a network-based robot according to example embodiments;

FIG. 3 is a control block diagram showing an image transmission system of a network-based robot according to example embodiments;

FIG. 4 is a control block diagram of an image separation unit to separate a camera image in a network-based robot according to example embodiments;

FIG. 5 is a detailed block diagram showing the control configuration of an image transmission system of a network-based robot according to example embodiments;

FIG. 6 is a control block diagram of an image synthesis unit to synthesize an image in a network-based robot according to example embodiments; and

FIG. 7 is a flowchart illustrating an image transmission method of a network-based robot according to example embodiments.

### DETAILED DESCRIPTION

Reference will now be made in detail to the embodiments, examples of which are illustrated in the accompanying drawings.

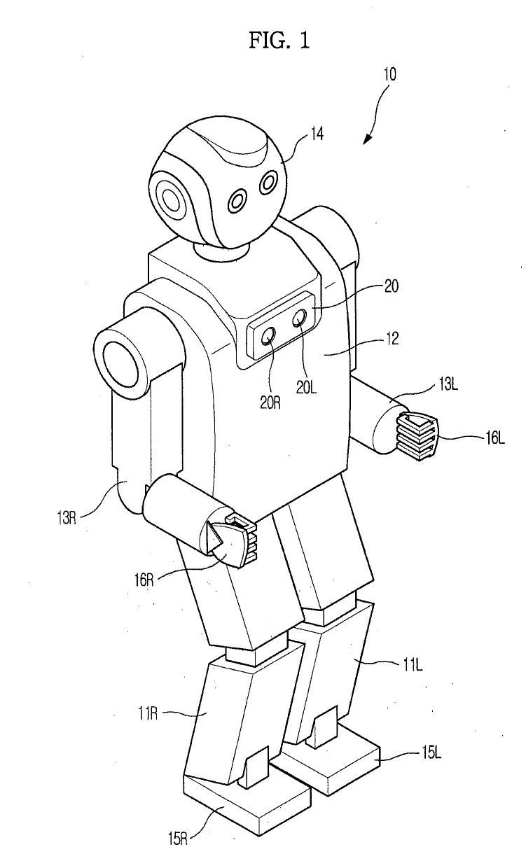

FIG. 1 is an appearance view showing an example of a network-based robot according to example embodiments.

In FIG. 1, the network-based robot 10 according to the example embodiments is a bipedal robot which walks erect using two legs 11L and 11R similar to a human, and includes a trunk 12, two arms 13L and 13R and a head 14. Feet 15L and 15R and hands 16L and 16R are included on the front ends of the legs 11L and 11R and the arms 13L and 13R, respectively.

A stereo camera 20 to acquire an image through two left and right cameras 20L and 20R is placed on the upper side of the trunk 12. The location of the stereo camera 20 is not limited to the trunk 12 of the network-based robot 10 and may be placed at any location where an image may be acquired. For example, the stereo camera may be placed on the head 14.

In the reference numerals, L and R denote left and right, respectively.

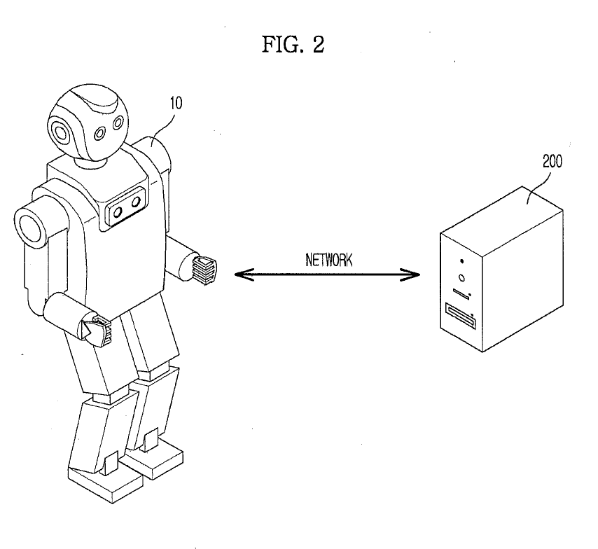

FIG. 2 is a view showing the overall configuration of an image transmission system of a network-based robot according to example embodiments.

In FIG. 2, the network-based robot 10 separates an image acquired by the stereo camera 20 into various image formats and transmits the various image formats to a server unit 200. The server unit 200 synthesizes the various image formats into an image format suitable for a service request and provides an image service such as face recognition, object recognition, navigation or monitoring.

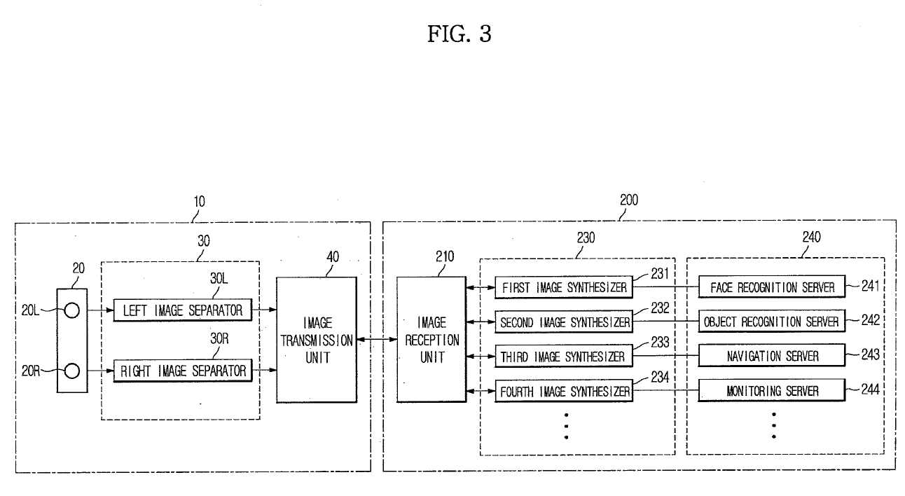

FIG. 3 is a control block diagram showing an image transmission system of a network-based robot according to example embodiments.

In FIG. 3, the network-based robot 10 includes a stereo camera 20 to acquire an image, an image separation unit 30 to separate the acquired image into various image formats, and an image transmission unit 40 to transmit the separated various image formats to a service server.

The stereo camera 20 acquires a color image with a size of 640(X)*480(Y) through two left and right cameras 20L and 20R and inputs the color image to the image separation unit 30.

The image separation unit 30 includes a left image separator 30L to separate the color image with the size of 640(X)*480(Y), which is received from the left camera 20L, into various image formats and to store the various image formats and a right image separator 30R to separate the color image with the size of 640(X)*480(Y), which is received from the right camera 20R, into various image formats and to store the various image formats.

The server unit 200 includes an image reception unit 210 to receive the various image formats transmitted from the network-based robot 10 over a network, an image synthesis unit 230 to synthesize the received various image formats into an image suitable for an image request such as face recognition, object recognition, navigation or monitoring, and a service server 240 to provide an image service using the synthesized image suitable for the image request.

The image synthesis unit 230 includes a first image synthesizer 231 to synthesize the image formats into an image format (e.g., 320*240, color, and 10 fps) suitable for face recognition, a second image synthesizer 232 to synthesize the image formats into an image format (e.g., 640*480, color, and 5 fps) suitable for object recognition, a third image synthesizer 233 to synthesize the image formats into an image format (e.g., 320*240, monochrome, and 20 fps) suitable for navigation, and a fourth synthesizer 234 to synthesize the image formats into an image format (e.g., 640*480, color, and 10 fps) suitable for remote monitoring. If a service using a new image is added, an image synthesizer to synthesize the image formats into an image format requested by this service may be further provided.

The service server 240 includes a face recognition server 241 to provide an image service for face recognition, an object recognition server 242 to provide an image service for object recognition, a navigation server 243 to provide an image service for navigation, and a monitoring server 244 to provide an image service for remote monitoring. Even in the service server 240, similar to the image synthesis unit 230, if a service server 240 using a new image is added, the image formats may be synthesized into an image format requested by this service server 240 to provide a service.

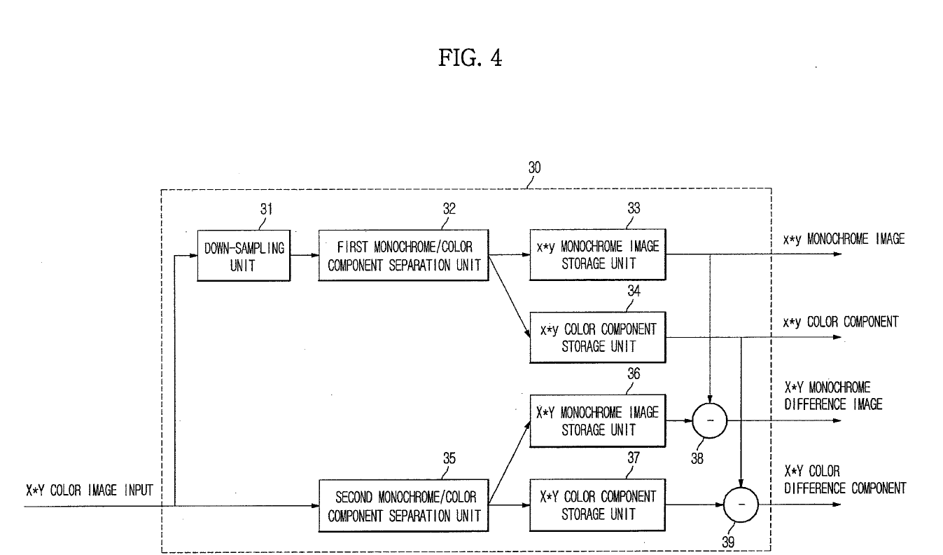

FIG. 4 is a control block diagram of an image separation unit to separate a camera image in a network-based robot according to example embodiments.

In FIG. 4, the image separation unit 30 includes a down-sampling unit 31 to reduce a color image with a size of 640(X)*480(Y) received from the stereo camera 20 (left or right camera) to a color image with a size of 320(x)*240 (y); a first monochrome/color component separation unit 32 to separate the color image with the size of 320(x)*240 (y) into a monochrome component and a color component; an x*y monochrome image storage unit 33 to store the monochrome image with the size of 320(x)*240(y), which is separated by the first monochrome/color component separation unit 32, in a buffer; an x*y color component storage unit 34 to store the color component with the size of 320(x)*240(y), which is separated by the first monochrome/color component separation unit 32, in a buffer; a second monochrome/color component separation unit 35 to separate the color image with the size of 640(X)*480(Y), which is received from the stereo camera 20, into a monochrome component and a color component; an X*Y monochrome image storage unit 36 to store the monochrome image with the size of 640(X)*480(Y), which is separated by the second monochrome/color component separation unit 35, in a buffer; an X*Y color component storage unit 37 to store the color component with the size of 640(X)*480(Y), which is separated by the second black/color component separation unit 35, in a buffer; a first calculation unit 38 to obtain a difference between the monochrome image with the size of 320(x)*240(y) stored in the x*y monochrome image storage unit 33 and the monochrome image with the size of 640(X)*480(Y) stored in the X*Y monochrome image storage unit 36; and a second calculation unit 39 to obtain a difference between the color component with the size of 320(x)*240(y) stored in the x*y color component storage unit 34 and the color component with the size of 640(X)*480(Y) stored in the X*Y color component storage unit 37. The first calculation unit 38 and the second calculation unit 39 convert the monochrome image and the color component with the size of 320(x)*240(y) into the size of 640(X)*480(Y) using linear up-sampling and then obtain a difference therebetween.

In FIG. 4, either the left or right image separator 30L and 30R may be the image separation unit 30. The components of FIG. 4 are provided in the left or right image separator 30L or 30R to separate the image using the same method.

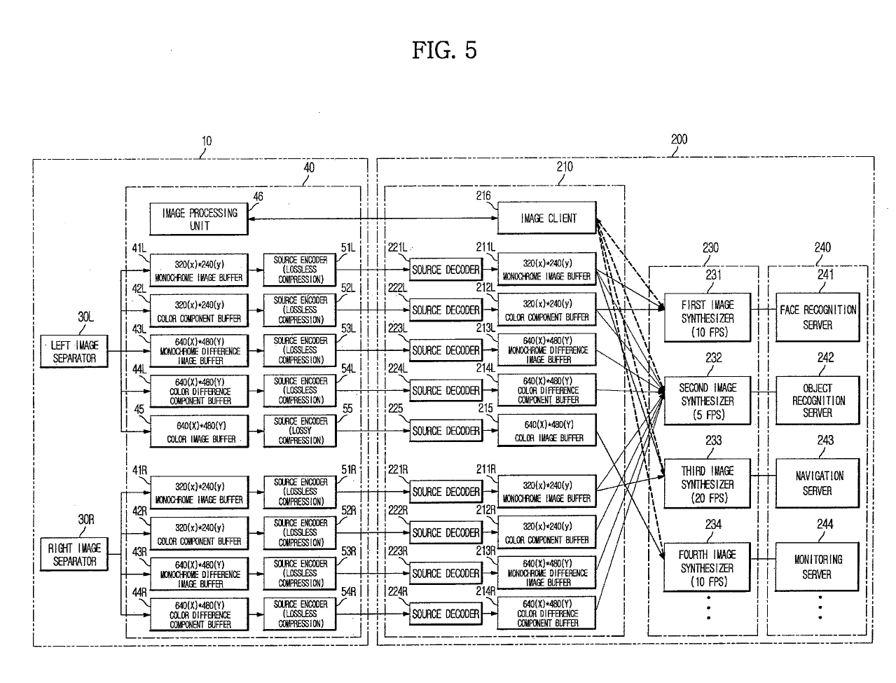

FIG. 5 is a detailed block diagram showing the control configuration of an image transmission system of a network-based robot according to example embodiments.

In FIG. 5, the image transmission unit 40 of the network-based robot 10 includes left and right 320(x)*240(y) monochrome image buffers 41L and 41R to receive and store the monochrome images with the size of 320(x)*240(y), which are separated by the left and right image separators 30L and 30R of the image separation unit 30; left and right 320(x)*240(y) color component buffers 42L and 42R to receive and store the color components with the size of 320(x)*240(y), which are separated by the left and right image separators 30L and 30R; left and right 640(X)*480(Y) monochrome difference image buffers 43L and 43R to receive and store the difference between the monochrome images with the size of 640(X)*480(Y), which are separated by the left and right image separators 30L and 30R; left and right 640(X)*480(Y) color difference component buffers 44L and 44R to receive and store the difference between the color components with the size of 640(X)*480(Y), which are separated by the left and right image separators 30L and 30R; and a 640(X)*480(Y) color image buffer 45 which is a path to transfer the color image with the size of 640(X)*480(Y), which is separated by the left image separator 30L.

The image transmission unit 40 further includes an image processing unit 46 to determine the frame rate (fps) to be transmitted by the left and right 320(x)*240(y) monochrome image buffers 41L and 41R, the left and right 320(x)*240(y) color component buffers 42L and 42R, the left and right 640(X)*480(Y) monochrome difference image buffers 43L and 43R, and the left and right 640(X)*480(Y) color difference component buffers 44L and 44R, according to an image reception request of the image synthesis unit 230. If the image processing unit 46 determines the frame rate (fps) to be transmitted, the buffers 41L and 41R, 42L and 42R, 43L and 43R, and 44L and 44R synchronously transmit the images. At this time, each of the transmitted images has a frame number.

In addition, the image transmission unit 40 further includes source encoders 51L and 51R, 52L and 52R, 53L and 53R, and 54L and 54R to compress the images transmitted from the left and right 320(x)*240(y) monochrome image buffers 41L and 41R, the left and right 320(x)*240(y) color component buffers 42L and 42R, the left and right 640(X)*480(Y) monochrome difference image buffers 43L and 43R, and the left and right 640(X)*480(Y) color difference component buffers 44L and 44R through respective channels using a lossless compression method; and a source encoder 55 to compress the 640(X)*480(Y) color image transmitted from the 640(X)*480(Y) color image buffer 45 using a lossy compression method.

Although in the example embodiments the 640(X)*480(Y) color image separated by the left image separator 30L is used in the 640(X)*480(Y) color image buffer 45, the example embodiments are not limited thereto and the 640(X)*480(Y) color image separated by the right image separator 30R may be used.

In FIG. 5, the image reception unit 210 of the server unit 200 includes left and right 320(x)*240(y) monochrome image buffers 211L and 211R, left and right 320(x)*240(y) color component buffers 212L and 212R, left and right 640(X)*480(Y) monochrome difference image buffers 213L and 213R and left and right 640(X)*480(Y) color difference component storage units 214L and 214R and a 640(X)*480(Y) color image buffer 215 to receive and store the images through the left and right 320(x)*240(y) monochrome image buffers 41L and 41R, the left and right 320(x)*240(y) color component buffers 42L and 42R, the left and right 640(X)*480(Y) monochrome difference image buffers 43L and 43R, the left and right 640(X)*480(Y) color difference component buffers 44L and 44R, and the 640(X)*480(Y) color image buffer 45.

In addition, the image reception unit 210 further includes an image client 216 to analyze the request of the accessed service server 240 (241 to 244), to determine data to be transmitted by the left and right 320(x)*240(y) monochrome image buffers 41L and 41R, the left and right 320(x)*240(y) color component buffers 42L and 42R, the left and right 640(X)*480(Y) monochrome difference image buffers 43L and 43R, and the left and right 640(X)*480(Y) color difference component buffers 44L and 44R of the image transmission unit 40, and to transmit the frame rate satisfying all requirements.

The image reception unit 210 further includes source decoders 221L and 221R, 222L and 222R, 223L and 223R, 224L and 224R, and 225 respectively corresponding to the source encoders 51L and 51R, 52L and 52R, 53L and 53R, 54L and 54R, and 55, in order to restore the images compressed by the source encoders 51L and 51R, 52L and 52R, 53L and 53R, 54L and 54R, and 55 of the image transmission unit 40.

In FIG. 5, the image synthesis unit 230 of the server unit 200 includes a first image synthesizer 231 to request a 320(x)*240(y) color separation image necessary for synthesizing the image formats into the image format (e.g., 320*240, color, and 10 fps) suitable for face recognition (left camera and 10 fps); a second image synthesizer 232 to request a 640(X)*480(Y) color separation image necessary for synthesizing the image formats into the image format (e.g., 640*480, color, and 5 fps) suitable for object recognition (left and right cameras, and 5 fps); a third image synthesizer 233 to request a 320(x)*240(y) color separation image necessary for synthesizing the image formats into the image format (e.g., 320*240, monochrome, and 20 fps) suitable for navigation (left and right cameras, and 20 fps); and a fourth image synthesizer 234 to request a 640(X)*480(Y) color separation image necessary for synthesizing the image formats into the image format (e.g., 640*480, color, and 10 fps) suitable for remote monitoring (left camera, and 10 fps).

The first to fourth image synthesizers 231 to 234 are provided in correspondence with the face recognition server 241, the object recognition server 242, the navigation server 243 and the monitoring server 244 of the service server 240 to transmit an image request signal to the client processing unit 216 of the image reception unit 210 in order to synthesize the images requested by the service server 240 (241 to 244).

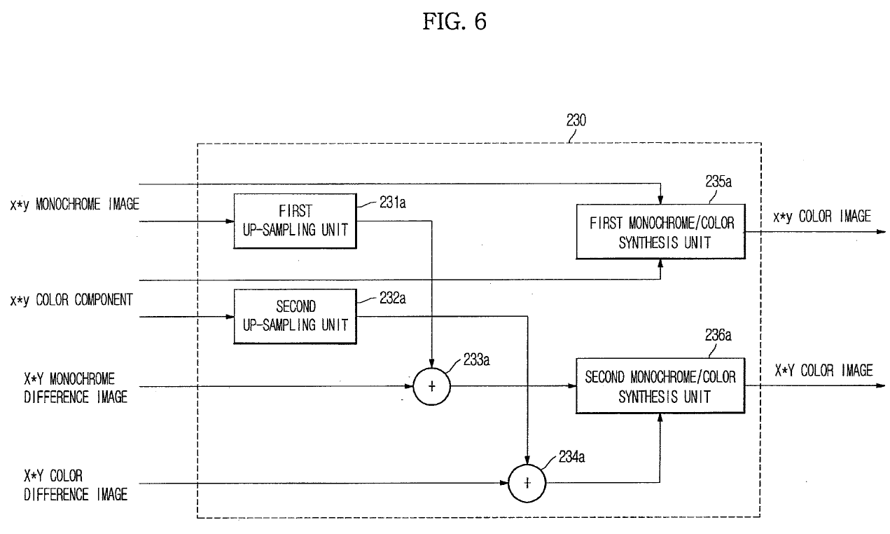

FIG. 6 is a control block diagram of an image synthesis unit to synthesize an image in a network-based robot according to example embodiments.

In FIG. 6, the image synthesis unit 230 includes a first up-sampling unit 231a to enlarge the 320(x)*240(y) monochrome image transmitted from the left or right 320(x)*240(y) monochrome image buffer 211L or 211R of the image reception unit 210 to a 640(X)*480(Y) monochrome image; a second up-sampling unit 232a to enlarge the 320(x)*240(y) color component transmitted from the left or right 320(x)*240(y) color component buffer 212L or 212R of the image reception unit 210 to a 640(X)*480(Y) color component; a first calculation unit 233a to add the 640(X)*480(Y) monochrome image enlarged by the first up-sampling unit 231a and the 640(X)*480(Y) monochrome difference image transmitted from the left or right 640(X)*480(Y) monochrome difference image buffer 213L or 213R of the image reception unit 210; a second calculation unit 234a to add the 640(X)*480(Y) color component enlarged by the second up-sampling unit 232a and the 640(X)*480(Y) color difference component transmitted from the left or right 640(X)*480(Y) color difference component buffer 214L or 214R of the image reception unit 210; a first monochrome/color synthesis unit 235a to synthesize the 320(x)*240(y) monochrome image transmitted from the left or right 320(x)*240(y) monochrome image buffer 211L or 211R of the image reception unit 210 and the 320(x)*240(y) color component transmitted from the left or right 320(x)*240(y) color component buffer 212L or 212R of the image reception unit 210 and to output a 320(x)*240(y) color image; and a second monochrome/color synthesis unit 236a to synthesize the 640(X)*480(Y) monochrome image obtained by the first calculation unit 233a and the 640(X)*480(Y) color component obtained by the second calculation unit 232a and to output a 640(X)*480(Y) color image.

Although, in FIG. 6, the image synthesis unit 230 using one of the left and right images is described, the components of FIG. 6 may be provided with respect to both the left and right images to restore the original image using the same method and transmit the original image as a service.

Hereinafter, the operation and effect of the image transmission system of the network-based robot having the above configuration and the method thereof will be described.

The network-based robot 10 including one stereo camera 20 transmits the image acquired by the stereo camera 20 to the server unit 200 which will use the image for a robot service as shown in FIG. 2. The server unit 200 analyzes the image transmitted from the network-based robot 10 and informs the network-based robot 10 of information regarding the image or provides an image service to a user. The service server 240 (241 to 244) for the image service requests the image which may be maximally processed by the service server in consideration of a difference in a desired image size/monochrome or color/fps.

For example, the network-based robot 10 may provide four different services using the image acquired using the stereo camera 20. These services are described below.

The image format varies according to the types of the services provided by the network-based robot 10 using the image. Accordingly, in order to provide respective services, different image formats are necessary. For example, Table 1 shows image formats suitable for services such as face recognition, object recognition, navigation and monitoring.

TABLE 1

| | | | | Number | |
|---|---|---|---|---|---|
| | | | Frame | of | Recommended |
| Type | Size | Color | (fps) | cameras | compression |
| Navigation | 320(x) * 240(y) | Mono- | >20 | 2EA | Lossless |
| | | chrome | | | |
| Face | 320(x) * 240(y) | Mono- | >10 | 1EA | Lossless |
| recognition | | chrome | | | |
| Object | 640(X) * 480(Y) | Color | >5 | 2EA | Lossless |
| recognition | | | | | |
| Monitoring | 640(X) * 480(Y) | Color | >10 | 1EA | Lossy |

As shown in Table 1, the service server 240 (241 to 244) requests various images according to the size of the image, monochrome and color, fps, number of cameras 20 and a compression method. Since data recognition performance is influenced by a lossless compression method and a lossy compression method, for face recognition and object recognition, better performance may be obtained when the image is processed using the lossless compression method.

In order to satisfy all the conditions of Table 1, a color image with a size of 640(X)*480(Y) and a frame rate of 30 fps is transmitted and a color image with a size of 320(x)*240(y) and a frame rate of 30 fps is transmitted to satisfy the four services.

In the existing method, the amount of dummy data is increased when the image of the stereo camera 20 is transmitted to the network-based robot 10. For example, if an image suitable for face recognition has a size of 320(x)*240(y) and the frame rate of 10 fps and an image suitable for object recognition has a size of 640(X)*480(Y) and a frame rate of 5 fps, an image with a size of 640(X)*480(Y) and frame rate of 10 fps is transmitted in order to transmit an image suitable for both the face recognition server 241 and the object recognition server 242. Since the face recognition server 241 receives the image having a size greater than a desired size and reduces the image to an image with a size of 320(x)*240(y), the amount of dummy data is significantly increased. The object recognition server 242 receives an image with a size of 640(X)*480(Y) and the frame rate of 10 fps and uses only 5 frames.

For reference, a color image with a size of 640(X)*480(Y) and the frame rate of 30 fps is necessary for satisfying an image having the frame rate of 30 fps and a color image with a size of 640(X)*480(Y) and the frame rate of 10 fps. In this case, if network bandwidth necessary for transmitting a color image with a size of 640(X)*480(Y) and the frame rate of 30 fps is calculated using one channel, data processing of 640*480*3*30=27.648 MB=221.184 Mbps is necessary. If such data processing is performed using the network, transmission is not substantially performed and the amount of unnecessary data is increased. Even when an image with a size of 320(x)*240(y) is transmitted and an image with a size of 640(X)*480(Y) is transmitted through multiple channels, the image needs to be repeatedly transmitted.

In contrast, in the example embodiments, the network-based robot 10 including one stereo camera 20 separates the image acquired by the stereo camera 20 and transmits the images satisfying various formats using a lossless method as shown in FIG. 5, in order to efficiently satisfy various image formats.

Referring to FIG. 5, the images input through the left camera 20L and the right camera 20R of the stereo camera 20 are separated and transmitted by the image separation unit 30 as follows:

Left/right camera 20L or 20R: Monochrome image with a size of 320(x)*240(y),

Left/right camera 20L or 20R: Color-component image (excluding a monochrome component) with a size of 320(x)*240(y),

Left/right camera 20L or 20R: Monochrome difference image with a size of 640(X)*480(Y) (difference with monochrome image with a size of 320(x)*240(y)),

Left/right camera 20L or 20R: Color difference component with a size of 640(X)*480(Y) (difference with color component with a size of 320(x)*240(y)).

Each channel is compressed using a lossless compression method in order to prevent image loss. The service server 240 (241 to 244) using the image requests a necessary separation image and the frame rate through the image synthesis unit 230 (231 to 234). Accordingly, the image synthesis unit 230 (231 to 234) requests and synthesizes necessary images through communication with the image transmission unit 40 to transmit the separated image and transmits the synthesized image to the service server 240 (241 to 244) to provide a service.

The image output from the stereo camera 20 is separated by the left and right image separators 30L and 30R and the separated images are stored in the image buffers 41L and 41R, 42L and 42R, 43L and 43R, 44L and 44R and 45 of the image transmission unit 40.

The image processing unit 46 of the image transmission unit 40 receives an image reception request of the image client 216 and transmits the image to the image reception unit 210. The image client 216 receives the request of the service server 240 (241 to 244) connected thereto and determines data to be transmitted by the image buffers 41L and 41R, 42L and 42R, 43L and 43R, 44L and 44R, and 45 of the image transmission unit 40.

For example, in Table 1, the first image synthesizer 231 of the face recognition server 241 requests a size of 320(x)*240(y), color, the left camera 20L, and 10 fps, the second image synthesizer 232 of the object recognition server 242 requests a size of 640(X)*480(Y), color, the left and right cameras 20L and 20R, and 5 fps, the third image synthesizer 233 of the navigation server 243 requests a size of 320(x)*240(y), monochrome, the left and right cameras 20L and 20R, and 20 fps, and the fourth image synthesizer 234 of the monitoring server 244 requests a size of 640(X)*480(Y), color, the left camera 20L, and 10 fps.

The image client 216 of the image reception unit 210 analyzes the request and transmits the frame rate satisfying all requirements through the buffers 41L and 41R, 42L and 42R, 43L and 43R, 44L and 44R, and 45 of the image transmission unit 40.

Requested maximum values are as follows according to the buffers 41L and 41R, 42L and 42R, 43L and 43R, 44L and 44R, and 45:

Left camera 20L, size of 320(x)*240(y), monochrome: 20 fps,

Left camera 20L, size of 320(x)*240(y), color: 10 fps,

Left camera 20L, size of 640(X)*480(Y), monochrome: 5 fps,

Left camera 20L, size of 640(X)*480(Y), color: 5 fps,

Right camera 20R, size of 320(x)*240(y), monochrome: 20 fps,

Right camera 20R, size of 320(x)*240(y), color: 5 fps,

Right camera 20R, size of 640(X)*480(Y), monochrome: 5 fps,

Right camera 20R, size of 640(X)*480(Y), color: 5 fps.

When the image processing unit 46 of the image transmission unit 40 determines the frame rate to be transmitted by the buffers 41L and 41R, 42L and 42R, 43L and 43R, 44L and 44R, and 45, the buffers 41L and 41R, 42L and 42R, 43L and 43R, 44L and 44R, and 45 synchronously transmit the images. Each of the transmitted, images has a frame number.

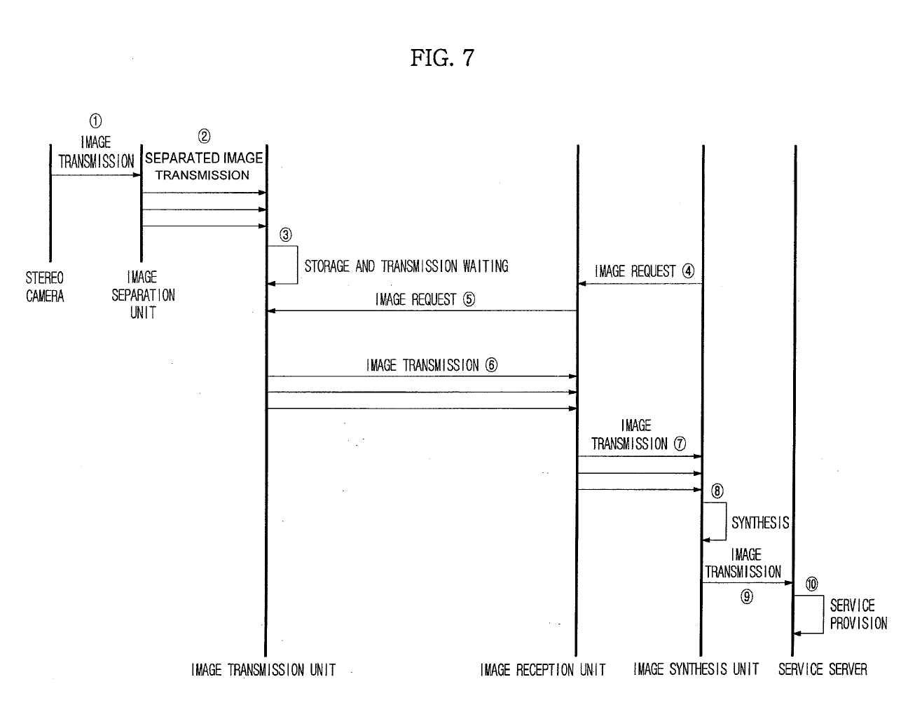

The image reception unit 210 receives and stores the transmitted image in the buffers 211L and 211R, 212L and 212R, 213L and 213R, 214L and 214R, and 215. The image synthesis unit 230 (231 to 234) of the service server 240 (241 to 244) fetches the stored images in a desired format, synthesizes the images, and transmits the synthesized image to the service server 240 (241 to 244). The service server 240 (241 to 244) performs a service using the received image. The overall flow is shown in FIG. 7.

FIG. 7 is a flowchart illustrating an image transmission method of a network-based robot according to example embodiments.

In FIG. 7, the stereo camera 20 acquires a color image with a size of 640(X)*480(Y) through two left and right cameras 20L and 20R and transmits the color image to the image separation unit 30 (1).

The image separation unit 30 separates the color image with the size of 640(X)*480(Y), which is transmitted from the stereo camera 20 (20L and 20R), into a monochrome image with a size of 640(X)*480(Y) and a color component/monochrome image with a size of 320(x)*240(y) and a color component. After the color image with the size of 640(X)*480(Y) is separated into the monochrome image and the color component, a difference between the image with the size of 640(X)*480(Y) and the image component with the size of 320(x)*240(y) is obtained and is transmitted to the image transmission unit 40 (2).

The image transmission unit 40 receives the images having various formats separated by the image separation unit 30 (30L and 30R), stores the images in the buffers 41L and 41R, 42L and 42R, 43L and 43R, 44L and 44R, and 45, and waits for transmission (3).

Thereafter, the service server 240 (241 to 244) requests a necessary separated image and the frame rate through the image synthesis unit 230 (231 to 234) (4), and the image client 216 of the image reception unit 210 analyzes the image reception request of the service server 240 (241 to 244) connected thereto and communicates with the image transmission unit 40 to transmit the separated image (5).

Accordingly, the image processing unit 46 of the image transmission unit 40 receives the image reception request of the image client 216 and the frame rates (fps) of the images stored in the buffers 41L and 41R, 42L and 42R, 43L and 43R, 44L and 44R, and 45. When an image is transmitted, a frame number for synchronization is transmitted therewith. At this time, if a lossless compression is necessary for each separated image (if network bandwidth is insufficient), lossless compression is performed. If the lossless compression is performed, the image with a size of 640(X)*480(Y) has only a difference and thus a lossless compression ratio is excellent. If the service server 240 (241 to 244) for the image service of the network-based robot 10 is included in the network-based robot 10, the image transmission unit 40 and the image reception unit 210 may be combined. At this time, a source encoder and a source decoder are not necessary and the request of the image synthesis unit 230 (231 to 234) may be directly transmitted. The image reception unit 210 receives and stores the transmitted images in the buffers 211L and 211R, 212L and 212R, 213L and 213R, 214L and 214R, and 215 (6).

Then, the image synthesis unit 230 (231 to 234) of the service server 240 (241 to 244) fetches the images stored in the buffers 211L and 211R, 212L and 212R, 213L and 213R, 214L and 214R, and 215 of the image reception unit 210 (7) and synthesizes the images (8).

For example, color images having a size of 640(X)*480(Y) and a frame rate of 5 fps, acquired by the left and right cameras 20L and 20R, are transmitted for object recognition. In the transmitted images, an image having a size of 320(x)*240(y) is input to the first monochrome/color synthesis unit 235a of the image synthesis unit 230 to output a color image having a size of 320(x)*240(y), an image enlarged by the first and second up-sampling units 231a and 232a and the monochrome/color image component having a size of 640(X)*480(Y) are synthesized, and an image having a size of 640(X)*480(Y) is output from the second monochrome/color synthesis unit 236a (see FIG. 6). The same process is performed with respect to the left and right cameras of the stereo camera 20 to restore, transmit an original image, and provide a service.

Thereafter, the image synthesis unit 230 (231 to 234) transmits the synthesized image to the service server 240 (241 to 244) (9). The service server 240 (241 to 244) provides the service using the received image (10).

In example embodiments, if an image is transmitted, a lossless compression method is used in order to prevent image data from being lost. The lossless compression method is used with respect to a difference image between channels. Since the performance of the lossless compression method varies according to data, in the example embodiments, the description of gain due to lossless compression is omitted. Since image data of a difference may be compressed to a size significantly smaller than that of actual image data, gain may be obtained in terms of transmission of a large amount of data.

Although embodiments have been shown and described, it should be appreciated by those skilled in the art that changes may be made in these embodiments without departing from the principles and spirit of the disclosure, the scope of which is defined in the claims and their equivalents.

What is claimed is:

1. An image transmission system, comprising:
a camera configured to acquire an image;
an image separation unit configured to separate the image acquired by the camera into a plurality of image formats;
an image transmission/reception unit configured to store the plurality of separated image formats and to transmit the plurality of stored image formats according to an image request;
an image synthesis unit configured to synthesize the plurality of image formats transmitted by the image transmission/reception unit into an image suitable for the image request; and
a service server configured to provide an image service using the synthesized image.

2. The image transmission system according to claim 1, wherein the camera is a stereo camera which is provided in the network-based robot to acquire a color image with a size of 640(X)*480(Y).

3. The image transmission system according to claim 2, wherein the image separation unit separates the color image with the size of 640(X)*480(Y), which is acquired by the stereo camera, into parts including a monochrome image with a size of 640(X)*480(Y)/color component and a monochrome image with a size of 320(x)*240(y)/color component and transmits the parts to the image transmission/reception unit.

4. The image transmission system according to claim 3, wherein the image separation unit separates the color image with the size of 640(X)*480(Y) into the monochrome image and the color component, obtains a difference between the color image with the size of 640(X)*480(Y) and an image component with the size of 320(x)*240(y), and transmits the difference to the image transmission/reception unit.

5. The image transmission system according to claim 4, wherein the image transmission/reception unit includes:
an image transmission unit configured to transmit the plurality of separated image formats over a network according to the image request; and
an image reception unit configured to receive and store the plurality of image formats transmitted over the network.

6. The image transmission system according to claim 5, wherein the image transmission unit further includes buffers configured to store the plurality of separated image formats and an image processing unit configured to determine the frame rate to be transmitted by the buffers according to an image reception request of the service server.

7. The image transmission system according to claim 6, wherein the image transmission unit compresses the plurality of image formats to be transmitted by the buffers using a lossless compression method.

8. The image transmission system according to claim 6, wherein the image reception unit further includes buffers configured to store the plurality of image formats transmitted by the image transmission unit and an image client configured to analyze the image request of the service server and to determine the image formats to be transmitted by the buffers.

9. The image transmission system according to claim 8, wherein the image synthesis unit fetches and synthesizes the image formats stored in the buffers into an image suitable for the image request according to the image request of the service server.

10. The image transmission system according to claim 1, wherein the service server includes a face recognition server, an object recognition server, a navigation server and a monitoring server.

11. An image transmission system of a network-based robot, comprising:
a robot configured to separate an image acquired by a camera into a plurality of image formats and to transmit the plurality of image formats; and
a server configured to synthesize the plurality of image formats and to provide a service, wherein the robot transmits the plurality of image formats to the server over a network.

12. The image transmission system according to claim 11, wherein the robot includes:
an image separation unit configured to separate the image acquired by the camera into the plurality of image formats; and
an image transmission unit configured to store the plurality of separated image formats and to transmit the plurality of stored image formats to the server according to an image request of the server.

13. The image transmission system according to claim 12, wherein the image separation unit separates a color image having a size of 640(X)*480(Y), which is acquired by the camera, into parts including a monochrome image with a size of 640(X)*480(Y)/color component and a monochrome image with a size of 320(x)*240(y)/color component and transmits the parts to the image transmission unit.

14. The image transmission system according to claim 13, wherein the image separation unit separates the color image with the size of 640(X)*480(Y) into the monochrome image and the color component, obtains a difference between the color image with the size of 640(X)*480(Y) and an image component with the size of 320(x)*240(y), and transmits the difference to the image transmission unit.

15. The image transmission system according to claim 12, wherein the image transmission unit compresses the plurality of image formats using a lossless compression method and transmits the compressed image formats.

16. The image transmission system according to claim 12, wherein the server includes:
an image reception unit configured to receive and store the plurality of image formats transmitted from the image transmission unit over the network; and
an image synthesis unit configured to fetch and synthesize the plurality of stored image formats into an image suitable for the image request according to the image request.

17. A method of transmitting an image between a robot and a server over a network, the method comprising:
at the robot, separating, by a first processor, an image acquired by a camera into a plurality of image formats and transmitting the plurality of image formats to the server; and
at the server, synthesizing, by a second processor, the plurality of image formats and providing a service according to an image request.

18. The method according to claim 17, wherein the robot separates the color image with a size of 640(X)*480(Y), which is acquired by the camera, into parts including a monochrome image with a size of 640(X)*480(Y)/color component and a monochrome image with a size of 320(x)*240(y)/color component and transmits the parts to the server.

19. The method according to claim 17, wherein the robot compresses the plurality of image formats using a lossless compression method and transmits the compressed plurality of image formats to the server.

20. The method according to claim 17, wherein the server synthesizes the plurality of transmitted image formats into an image suitable for the image request and provides a service.
